(19) United States
(12) Patent Application Publication
(10) Pub. No.: US 2016/0040050 A1
(43) Pub. Date: Feb. 11, 2016

(54) REPAIR LIQUID FOR CONVEYOR BELTS

(71) Applicant: SIKA TECHNOLOGY AG, Baar (CH)

(72) Inventors: Hector MUÑOZ, Santiago (CL); Pedro GALLEGOS, Santiago (CL); Thomas HAACK, Santiago (CL)

(73) Assignee: Sika Technology AG, Baar (CH)

(21) Appl. No.: 14/776,312

(22) PCT Filed: Mar. 12, 2014
(86) PCT No.: PCT/EP2014/054850

§ 371 Date: Sep. 14, 2015

(30) Foreign Application Priority Data
Mar. 15, 2013 (EP) 13159610.8

(51) Int. Cl. C09J 175/08; C08L 75/06; C08J 7/04; C09J 5/00; C09J 5/04; C08L 75/08; C09J 175/06

(52) U.S. Cl. CPC C09J 175/08; C08L 75/08; C08L 75/06; C09J 175/06; C09J 5/00; C09J 5/04; C08J 7/04; C09J 2475/00

(57) ABSTRACT

A polyurethane-based composition is disclosed which includes a polyurethane prepolymer, a solvent, a plasticizer and a curing agent, wherein the curing agent contains a mononuclear aromatic polyamine, and is present in an amount such that the molar ratio of all amine functions in the polyamine to all isocyanate functions in the composition is at least 0.7 to 1. Such polyurethane-based compositions have proven effective for example as adhesives and fillers in the repair of elastic substrates since they can be processed quickly and readily even at low temperatures. Methods are also disclosed for bonding or repairing elastic substrates that include corresponding polyurethane-based compositions, and to use of the composition for bonding and repairing elastic substrates.

### TECHNICAL FIELD

The invention relates to a polyurethane-based composition for use as an adhesive or filler for elastic substrates, comprising at least two components, and containing a polyurethane prepolymer as constituent of a first component, a curing agent as constituent of a second component that is physically separate from the first component, a solvent and a plasticizer, wherein the curing agent comprises a mononuclear aromatic diamine and is present in an amount such that the molar ratio of all amine functions in the diamine to all isocyanate functions in the adhesive is at least 0.7 to 1. Furthermore, the present invention relates to a method for repairing defects such as cracks or holes in elastic substrates and for bonding elastic substrates, and to a use of said composition for bonding and repairing elastic substrates, particularly in the context of repairing conveyor belts.

### BACKGROUND OF THE INVENTION

Currently, conveyor systems provide the most powerful means of transporting solid materials in the mining industry. The conveyor belt technology has developed very sophisticated mechanical systems over time, which may include, for example, frames, conveyor rollers, idler rollers, gears, elevators, belt wagons, damage sensors and brake systems. Furthermore, conveyor assemblies can have main or secondary lines that can run both above ground and below ground.

The conveyor belt is the element of such conveyor systems that comes into direct contact with the transported material. It normally consists of a multi-layered element which can be reinforced with different materials. The surface layer usually consists of natural or synthetic rubber such as SBR or a combination thereof. In addition, depending on the particular application, other materials such as polymers or steel may be used. There are various types of conveyor belts for wet and dry materials, materials comprised of large and small particles, solids of different hardness, or the transport of acids.

The mining industry is the industry with the greatest need for conveyor belt systems. In particular, in Latin American countries such as Chile, steady growth of this industry in the next 10 years is expected.

In the case of conveyor belt systems their ‘availability’ is a critical feature. The ‘availability’ refers to the time during which the system can be used effectively, divided by the total available time. Since times when the conveyor belt is not running go hand in hand with high costs, there is a need to optimize the availability of conveyor belts.

As a result of their use, conveyor belts are subject to high wear, so that repairs of cracks or other damage are often required. However, many of the polyurethane-based repair systems currently available on the market have the disadvantage that they cure relatively slowly or bond insufficiently to the material of the conveyor belt. This can cause the equipment to be idle for a relatively long of time for repair, which is associated with considerable costs, since the conveying must be interrupted for that period of time. Therefore, there is a need for repair systems for conveyor belts which can be applied as quickly as possible and which also cure very quickly in order to minimize the idle time of the conveyor belts.

At the same time, repair systems should have a Shore A hardness which is close to that of the conveying materials, so that a uniform surface is formed. It has been shown that conveyor belts having a Shore A hardness in the range of 50 to 90 have optimum properties with respect to their wear.

Furthermore, there is a need for compositions that can be used in a wide temperature range. Conveyor belts are used in areas such as the Atacama Desert in Chile, where very different temperatures can exist. When repairing conveyor belts, it is often impossible to remove single elements or the entire belt from the system and to transport it to a repair location. For such applications it is therefore necessary to repair the belt on site under ambient conditions. Particularly at low temperatures below 10° C. this causes difficulties because at these temperatures the available repair systems are often highly viscous and cure only slowly. Therefore, there is also a need for repair systems for conveyor belts which can be applied at such low temperatures and yet are sufficiently reactive to enable rapid curing.

Another disadvantage of repair systems available on the market is that they often require a formulation containing CFCs (chlorofluorocarbons). Today, their use is no longer justified because of the ozone-damaging potential of these compounds, particularly since capture of the CFC emissions is not possible.

U.S. Pat. No. 4,465,535 describes a process for repairing damaged articles made of cured rubber, wherein the site to be repaired is treated first with a halogen-containing oxidizing agent, and then a polyurethane prepolymer-based repair composition is applied. The curing agents described for these compositions include 4,4′-methylene dianiline (MDA) and 2,3-di-(4-aminophenyl)butane, respectively, and halogen salts of these amines.

U.S. Pat. No. 4,071,492 describes polyurethane/urea elastomers based on propylene oxide/tetrahydrofuran copolymers. For the preparation of such elastomers, first, hydroxy-functional propylene oxide/tetrahydrofuran copolymers are reacted with polyisocyanates, which are then reacted further by the addition of aromatic diamines such as 4,4′-methylene dianiline to form an elastomer.

Similarly, U.S. Pat. No. 4,327,138 describes a process for repairing damaged articles made of elastomers, particularly tires, wherein a curable polymer or prepolymer is used and, optionally, a pretreatment with chlorinated oxidizing agents is carried out. The curable prepolymers described include, inter alia, polyurethane prepolymers based on polytetramethylene glycol which are cured with compounds such as 4,4′-methylenebis-(2-chloroaniline) or 4,4′-methylene dianiline and halogen salt complexes thereof. However, the curing agents used in the two disclosures above have the disadvantage of being highly toxic.

U.S. Pat. No. 4,345,058 describes prepolymer compositions based on polyurethane prepolymers, in particular polyurethane prepolymers based on polytetramethylene glycol, in combination with plasticizers and solvents, which are cured using catalysts such as 1,4-diazabicyclo[2,2,2]octane, N,N,N-tetramethyl-1-3-butanediamine or 1,2,4-trimethylpiperazine.

Finally, WO 2012/029029 describes a liquid composition for the repair of rubber products and industrial coatings which is based on a polyurethane prepolymer, a solvent, a pigment and a catalyst, such as in particular diethyltoluylenediamine (DETDA). The principal subject of the investigations in this disclosure is the influence of different solvents on the application of the composition to influence its properties.

Compounds such as DETDA also have been described for purposes other than that of a curing agent. For example, US 2007/0276114 A1 describes aromatic diamines such as diethyltoluylenediamine as thixotropy inducing additive. In this context, the diamine causes thickening of the polyurethane when it is mixed with the polyol curing component. US 2008/264541 A1 describes diethyltoluylenediamine as possible chain extender for polyurethane prepolymers. In the two above-described applications, however, polyols are used as curing agent components, so that the molar ratio of all amine functions in the polyamine to all isocyanate functions in the compositions is less than 0.7:1.

The present invention solves these problems.

A first aspect of the present invention relates to a polyurethane-based composition having at least two components, comprising
a) a polyurethane prepolymer as a constituent of a first component,
b) a curing agent as a constituent of a second component that is physically separate from the first component,
c) a solvent, and
d) a plasticizer,
   wherein the curing agent comprises a mononuclear aromatic polyamine and is present in an amount such that the molar ratio of all amine functions in the polyamine to all isocyanate functions in the composition is at least 0.7 to 1.

In the context of the present invention, ‘mononuclear’ in relation to an aromatic polyamine means that the amine functions are substituents of the same aromatic ring.

The requirements ‘a polyurethane prepolymer, a solvent, . . . ’ are not to be understood to be limited thereto, i.e., mixtures of different polyurethane prepolymers, or mixtures of polyurethane prepolymers with other polymers, mixtures of solvents, mixtures of plasticizers as well as mixtures of curing agents can be used also.

With respect to the solvent and the plasticizer there are no restrictions on an allocation to specific components. The solvent and the plasticizer may be formulated as constituent of the first component, as constituent of the second component or any further component or distributed across a plurality of these components. The solvent should be inert with respect to the polyurethane prepolymer and have no reactive groups such as OH—, NH— or SH— groups.

In the present document, substance names beginning with ‘poly’ such as polyamine, polyisocyanate or polyol designate substances which formally contain two or more of the functional groups that occur in their name per molecule.

In the present document, the term ‘polymer’ comprises on the one hand a collective of chemically uniform macromolecules which differ with respect to degree of polymerization, molar mass and chain length, prepared by a poly reaction (polymerization, polyaddition, polycondensation). On the other hand, the term also comprises derivatives of such a collective of macromolecules from poly reactions, that is, compounds which were obtained by reactions, such as additions or substitutions, of functional groups on existing macromolecules and which may be chemically uniform or chemically nonuniform. The term further comprises so-called prepolymers, that is, reactive oligomeric preadducts whose functional groups are involved in the structure of macromolecules.

The term ‘polyurethane polymer’ comprises all polymers which are prepared by the so-called diisocyanate polyaddition process. This also includes those polymers which are virtually or entirely free of urethane groups. Examples of polyurethane polymers are polyether polyurethanes, polyester polyurethanes, polyether polyureas, polyureas, polyester polyureas, polyisocyanurates and polycarbodiimides.

In the context of the present invention, the term ‘polyurethane prepolymer’ designates polymers which have unreacted isocyanate groups and thus can be cured by adding a polyol or polyamine.

A suitable polyurethane prepolymer is obtainable by reacting at least one polyisocyanate with at least one polyol. This reaction may take place in that the polyol and the polyisocyanate are reacted by typical processes, for example at temperatures from 50° C. to 100° C., optionally with the use of suitable catalysts, wherein the polyisocyanate is dosed such that its isocyanate groups are in stoichiometric excess in relation to the hydroxyl groups of the polyol. Advantageously, the polyisocyanate is dosed such that an NCO/OH ratio of 1.2 to 5, in particular 1.5 to 3, is maintained. Here, the NCO/OH ratio is understood to be the ratio of the number of isocyanate groups used to the number of hydroxyl groups used. Preferably, a free isocyanate group content of 0.5 to 8% by weight, based on the total polyurethane prepolymer, remains after the reaction of all the hydroxyl groups of the polyol.

Polyols used for preparing a polyurethane prepolymer include, for example, the following commercially available polyols or mixtures thereof:
Polyoxyalkylene polyols, also referred to as polyether polyols or oligoetherols, which are polymerization products of ethylene oxide, 1,2-propylene oxide, 1,2- or 2,3-butylene oxide, tetrahydrofuran or mixtures thereof, possibly polymerized using a starter molecule having two or more active hydrogen atoms, such as, for example, water, ammonia or compounds with several OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the aforementioned compounds. Both polyoxyalkylene polyols which have a low degree of unsaturation (measured according to ASTM D-2849-69 and reported in milliequivalents of unsaturation per gram of polyol (meq/g)), prepared for example using so-called double metal cyanide complex catalysts (DMC catalysts), and polyoxyalkylene polyols having a higher degree of unsaturation, prepared, for example using anionic catalysts such as NaOH, KOH, CsOH or alkali alcoholates.

Particularly suitable are polyoxyalkylene diols or polyoxyalkylene triols, especially polytetramethylene glycol diols or polytetramethylene glycol triols.

Especially suitable are polyoxyalkylene diols or polyoxyalkylene triols having a degree of unsaturation of less than 0.02 meq/g and having a molecular weight in the range of 250 to 5,000 g/mol. In the context of the present invention, it has been shown that a polytetramethylene oxide polyol in the polyurethane prepolymer has preferably a molecular weight Mw in the range of about 250 to 4000 g/mol, and preferably from about 500 to 3000 g/mol, and particularly preferably from about 1000 to 2000 has. If the polytetramethylene polyol has a molecular weight of less than 250 g/mol, this will result in the material being difficult to process. However, if a polytetramethylene polyol with a molecular weight of more than 2000 is used, the resulting products will not have optimal hardness.

When in the foregoing a molecular weight is mentioned, the GPC method is used for its determination. This also applies to other molecular weights of polymers mentioned in connection with this invention.

Further suitable polyols related to the invention advantageously to be included in the polyurethane prepolymer include:
Polyester polyols, also referred to as oligoesterols, produced for example from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or anhydrides or esters thereof such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the abovementioned acids, and polyester polyols from lactones such as, for example, ε-caprolactone.
Polyacrylate or polymethacrylate polyols.
Polyhydrocarbonpolyols, also referred to as oligohydrocarbonols, such as, for example, polyhydroxy-functional ethylene-propylene, ethylene-butylene or ethylene-propylene-diene copolymers, as they are produced by the company Kraton Polymers, for example, or polyhdroxy-functional copolymers of dienes such as 1,3-butadiene or diene mixtures and vinyl monomers such as styrene, acrylonitrile or isobutylene, or polyhydroxy-functional polybutadiene polyols, such as, for example, those which are prepared by copolymerization of 1,3-butadiene or allyl alcohol and can also be hydrogenated.
Polyhydroxy-functional acrylonitrile/polybutadiene copolymers, as can be made, for example, from epoxides or amino alcohols and carboxyl-terminated acrylonitrile/polybutadiene copolymers (commercially available under the name of Hycar® CTBN from Noveon).

These polyols mentioned preferably have an average molecular weight of 250-30,000 g/mol, especially 1,000-30,000 g/mol, and preferably have an average OH functionality in the range of 1.6 to 3.

In addition to these polyols mentioned, small amounts of lower molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethlyolpropane, glycerol, pentaerythritol, sugar alcohols such as xylitol, sorbitol or mannitol, sugars such as sucrose, other polyhydric alcohols, low molecular weight alkoxylation products of the aforementioned dihydric and polyhydric alcohols, and mixtures of the aforementioned alcohols, may be used also when preparing the polyurethane prepolymer.

Polyisocyanates that can be used for preparing the polyurethane prepolymer include commercially available aliphatic, cycloaliphatic or aromatic polyisocyanates, especially diisocyanates, for example the following:

1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexane-1,3- and 1,4-diisocyanate and any mixtures of these isomers, 1-isocyanato-3,3,5-trimethyl-5-isocyanatomethyl cyclohexane (=isophorone diisocyanate or IPDI), perhydro-2,4′- and 4,4′-diphenylmethane diisocyanate (HMDI), 1,4-diisocyanato-2,2,6-trimethylcyclohexane (TMCDI), 1,3- and 1,4-bis-(isocyanatomethyl) cyclohexane, m- and p-xylylene diisocyanate (m- and p-XDI), m- and p-tetramethyl-1,3- and 1,4-xylylene diisocyanate (m- and p-TMXDI), bis-(1-isocyanato-1-methylenethyl)-naphthalene, 2,4- and 2,6-tolylene diisocyanate and any mixtures of these isomers (TDI), 4,4′-, 2,4′- and 2,2′-diphenylmethane diisocyanate and mixtures of these isomers (MDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), oligomers and polymers of the aforementioned isocyanates, and any mixtures of the aforementioned isocyanates. MDI, TDI, HDI and IPDI are preferred.

In a preferred embodiment the polyurethane prepolymer is the reaction product of at least one polyisocyanate and at least one polytetramethylene glycol polyol. Preferably, the polyisocyanate is an aromatic polyisocyanate, in particular TDI or MDI (toluene diisocyanate and diphenylmethane diisocyanate, respectively). Particularly preferably, the isocyanate is TDI.

In a particularly preferred embodiment, the polyurethane prepolymer used is a mixture of reaction products of polyether polyols, preferably polytetramethylene glycol polyols, with an aromatic polyisocyanate, preferably TDI, and polyester polyols with an aromatic polyisocyanate, preferably TDI. In the mixture, the polyether polyol-based polyurethane prepolymer preferably accounts for about 40 to 75% by weight, particularly preferably about 50 to 70% by weight and most preferably 60 to 70% by weight. The rest is the polyester polyol-based polyurethane prepolymer.

The polyurethane prepolymer according to the invention preferably has an isocyanate content of 2-8%, particularly preferably 2.2-7.5%. If a mixture as described above is used, the polyester polyol-based prepolymer preferably has an isocyanate content of about 3±0.5%, while the polyether polyol-based prepolymer has an isocyanate content of about 6±0.5%.

The content of the polyurethane prepolymer in the polyurethane-based composition, based on the total weight thereof, is preferably in the range of 40 to 94% by weight, particularly preferably 50 to 85% by weight, and most preferably 60 to 80% by weight.

The curing agent in the polyurethane-based composition according to the present invention is present preferably in the form of an aromatic diamine. In the context of the present invention, ‘aromatic amine’ means that the amine nitrogen atom is linked to an aromatic ring via a covalent bond. Furthermore, it is preferred if the polyamine has at least one, and preferably two primary amine functions.

Preferably, the aromatic diamine is 2,4- or 2,6-diethyltoluylenediamine or 2,4- or 2,6-dimethylthiotoluylene-diamine.

Compared to aliphatic amine curing agents such as DABCO (diazabicyclononane), meta-xylidenediamine (MXDA) and triethylenetetramine, the curing agents mentioned proved to be significantly more reactive and thus more effective. In addition, the resulting products have much higher values with respect to their elongation at break than is the case with the aliphatic amine curing agents.

It is also preferred in the context of the present invention that the curing agent is as free as possible of toxic amines, such as, for example, 4,4′-methylenedianiline or methylenebis-(o-chloroaniline). Surprisingly, it has been found advantageous that with mononuclear aromatic polyamines improved curing of the resulting product both after a short time (1 hour) and after complete curing (24 hours) of the composition can be achieved compared to binuclear aromatic polyamines, i.e., polyamines in which the amine functions are substituents of different aromatic rings.

With regard to the amount of the curing agent, the present invention is not subject to significant limitations. However, it is preferred that the curing agent is contained in the composition in an amount of 4 to 12% by weight, more preferably 5 to 9% by weight, and most preferably 6 to 8.5% by weight.

The molar ratio of the amine functions in the curing agent to the isocyanate functions in the composition is at least 0.7 to 1, preferably at least 0.8 to 1, in particular at least 0.9 to 1 and particularly preferably at least 0.95 to 1. On the other hand, a large excess of the amine functions in relation to the isocyanate functions results in formation of polymers having lower molecular weight, which can adversely affect the properties of the material. Therefore, the molar ratio of the amine functions in the curing agent to the isocyanate functions in the composition should not exceed 1.2:1, preferably not exceed 1.1:1. Most preferred is a ratio of about 1:1.

Accordingly, the curing agent should lead to as complete a reaction of the isocyanate groups as possible, and not merely bring about a chain extension of the polyurethane prepolymer.

In the context of the present invention, the solvent is also of essential importance. On the one hand, the solvent can be used to adjust a favorable processing viscosity. On the other hand, the solvent and the amount thereof should be chosen so that its evaporation does not delay or hinder the curing of the composition.

According to the invention, solvents to be included in the polyurethane-based composition in particular comprise non-aromatic solvents, preferably in the form of ethyl acetate, acetone, 4-methyl pentanone, cyclohexanone, 1,4-dioxane, methyl ethyl ketone, acetic acid, tetrahydrofuran, dimethylacetamide, chloroform, decalin, dimethylformamide, heptane, diisopropyl ether, ethanol, cyclohexane, hexane, methyl isobutyl ketone, and trichloroethylene. However, other suitable solvents which are preferred in the context of the present invention include aromatic solvents, in particular in the form of benzene, xylene or toluene. Of these, trichloroethylene and benzene are less preferred due to their toxicity.

Preferably, the solvent comprises a combination of ethyl acetate and xylene, particularly preferably a combination of ethyl acetate and xylene with heptane or trichloroethylene.

With regard to the content of solvents, the present invention is also not subject to any significant limitations. However, it is preferred to adjust the solvent content so that a suitable viscosity for processing is obtained. At the same time, the solvent content should not be higher than necessary because the solvent evaporates during or after application. A solvent content proven to be suitable is 1 to 60% by weight, preferably 5 to 30% by weight, and particularly preferably 10 to 20%, based on the total weight of the polyurethane-based composition.

The composition according to the invention contains at least one plasticizer as a further essential constituent. Suitable plasticizers are, for example, carboxylic acid esters, such as phthalates, in particular dioctyl phthalate, diisononyl phthalate, dibutyl phthalate or adipates, such as, for example, dioctyl adipate, acelates and sebacates, polyols, for example, polyoxyalkylenpolyole or polyester polyols, organic phosphoric and sulfonic acid compounds or polybutenes and aromatic alcohols such as benzyl alcohol or NCO-blocked polyurethane prepolymers based on TDI such as Poluren LP 100 LV or Poluren LP 100 from Sapici (Italy).

The content of the plasticizer should, but need not necessarily, be in the range of 1 to 20% by weight, preferably 2 to 15% by weight and particularly preferably 3 to 10% by weight, and in particular 4 to 7% by weight, based on the total weight of the composition.

A particularly suitable plasticizer in the context of the present invention is dibutyl phthalate.

In addition to these required constituents, the polyurethane-based composition can contain other constituents. Such constituents include, for example, organic and inorganic fillers, for example ground or precipitated calcium carbonates which are optionally coated with stearates, kaolins, aluminas, silicas, especially highly disperse silicas from pyrolysis processes, PCV powders or hollow beads. In the context of the present invention, it has been found to be advantageous when the compositions according to the invention do not contain substantial amounts of fillers, preferably less than 10% by weight, more preferably less than 5%, and most preferably less than 1% by weight of fillers. The best properties in terms of Shore A hardness after 60 minutes and elongation at break after one day were achieved with formulations in which no fillers such as calcium carbonate and/or kaolin were added. In the context of these inventions fillers do not include pigments, such as those that are described in the following.

Likewise, the composition according to the invention can contain pigments such as carbon blacks, in particular industrially produced carbon blacks (hereinafter referred to as carbon black) or black iron oxide. Suitably, such pigments can be included in the composition at a content of up to 8% by weight, preferably in the range of 0.5 to 6% by weight, and particularly preferably in the range of 2 to 3.5% by weight.

Furthermore, the compositions according to the invention may contain rheology modifiers, such as thickeners, for example urea compounds, polyamide waxes, bentonites or fumed silicas such as, for example, Aerosil 200 or Aerosil R972.

In addition, desiccants such as, for example, calcium oxide, molecular sieves, zeolites, highly reactive isocyanates such as p-tosyl isocyanate, orthoformic acid, alkoxysilanes such as tetraethoxysilane, organoalkoxysilanes such as trimethoxysilane and organoalkoxysilanes which have a functional group in alpha position to the silane may be used. p-Tosyl isocyanate is available, for example, as ‘Additive Ti’ from OMG Borchers GmbH. A suitable zeolite desiccant is ‘Baylith L Powder’ from UOP CH Sarl.

Additional adhesion promoters, in particular organoalkoxysilanes such as, for example, epoxy silanes, vinyl silanes, (methyl) acrylsilanes, isocyanatosilanes, oligomeric forms of these silanes may be added to the compositions of the invention. Likewise, stabilizers against heat, light and UV radiation and flame retardant agents or surfactants, such as wetting agents, leveling agents, deaerating agents or defoamers may be admixed. Commercially available defoamers are, for example, BYK 300, BYK 540 and BYK 501 from BYK and Mitell S and Schewo foam 6351 from Schwegmann.

In addition to the essential constituents mentioned, a preferred composition according to the invention contains one or more additives selected from defoamers, fillers, pigments, rheology modifiers and water-absorbent agents.

In the context of the present invention, it is further preferred if the composition after curing for one hour has a Shore A hardness (measured according to ASTM D 2240) of at least 60, preferably at least 70, and an elongation at break after 24 hours (measured according to ASTM D 412) of at least 300%, preferably at least 350%. In a particularly preferred embodiment, the elongation at break is in the range of about 400 to about 700%. Alternatively or cumulatively, the Shore A hardness after 60 minutes is preferably in a range from about 60 to about 90, preferably 70-80.

As described above, the individual constituents of the composition described are in the form of at least two components, wherein the individual constituents are divided up into a plurality of physically separate containers. Preferably, the constituents of the composition are present in the form of two components.

A suitable mixing ratio of the two components depends mainly on the particular composition of the two components. The composition containing the polyurethane component also cures solely with atmospheric moisture, while the second component leads to a strong acceleration of the curing rate of the composition. Therefore, the mixing ratio of the two components should be chosen so that the first component containing the polyurethane prepolymer (hereinafter component A) is present in the composition in a substantially greater quantity than the second component containing the curing agent (hereinafter component B). Preferred is a mixing ratio in the range of 100 parts by weight of the first component to 1 to 20 parts by weight of component B, particularly preferably 100 parts by weight of component A to 5 to 10 parts by weight of component B.

As already indicated above, the composition according to the invention may be used advantageously as a filler or adhesive.

A further aspect of the present invention therefore relates to a process for the bonding of elastic substrates, comprising

a) mixing a composition as described above,
b) coating a substrate S1 with the composition,
c) contacting the portion of the substrate S1 coated with the composition with a substrate S2, such that the composition is disposed between the two substrates, and
d) curing the composition.

Alternatively, the substrate S2 may be coated with the composition first and then brought into contact with the substrate S1. It is also possible to coat both substrate S1 and S2 with the composition. Then, the parts to be bonded are joined together, whereupon the composition cures. It should be ensured that the joining of the parts takes place within the so-called open time to ensure that the two joined parts are reliably bonded together.

Substrate S1 is preferably an elastic material, such as in particular natural or synthetic rubber, especially natural rubber, EPDM, NBR, SBR, SBS or SIS. Substrate S2 may be a different material or the same material as S1. Preferably, S1 and S2 are composed of the same material.

As already indicated, a further aspect of the present invention relates to a method for repairing defects such as cracks or holes in elastic substrates, comprising

a) mixing a polyurethane-based composition as described above,

b) introducing the composition into the defects, and

c) curing the composition.

By ‘defects’ is meant one or more defects.

In the context of the present invention, it has been found that the adhesion of the adhesive composition on the substrate can be improved by pretreating the substrate first with a halogen-containing adhesion promoter. Suitable halogen-containing adhesion promoters are, for example, halogen-containing oxidizing agents such as N-halosulfonamides, N-halohydantoins, N-haloamides, and N-haloimides. Examples of N-halosulfonamides include N,N,N′,N′-tetrachloro-oxybis (benzene sulfonamide), N,N,N′,N′-tetrachloro-4,4-biphenyl disulfonamide, N,N,N′,N′-tetrachloro-1,3-benzene disulfonamide, and N,N,N′,N′-tetrabromo-oxybis-(benzene sulfonamide). Examples of N-halohydantoins include 1,3-dichloro-5,5-dimethyl hydantoin, 1,3-dibromo-5,5-dimethyl hydantoin, 1,3-dichloro-5-methyl-5-isobutyl hydantoin, and 1,3-dichloro-5-methyl-5-hexyl hydantoin. Examples of N-haloamides include N-bromoacetamide and tetrachloroglycoluril. Examples of N-haloimides include N-bromosuccinimide and the various mono-, di- and tri-chloroisocyanuric acids, or mixtures thereof. A preferred halogen-containing oxidation agent is trichloroisocyanuric acid, which is also known as trichloro-s-triazinetrione or more specifically as 1,3,5-trichloro-s-triazine-2,4,6-trione.

Conventionally, the adhesion promoter is applied as a solution and the substrate is flashed off before the adhesive or the filler material is applied. Surprisingly, the pretreatment with such an adhesion promoter ensures improved adhesion of the adhesive over conventional adhesion promoters. Prior to application of the adhesion promoter, the substrate may be suitably cleaned and/or roughened.

A further aspect of the present invention finally relates to the use of a composition as described above for bonding or repairing defects, in particular cracks or holes, in elastic substrates. With regard to preferred substrates of this type, reference is made to the above comments about the processes. In a particularly preferred embodiment, the elastic substrate is the constituent of a conveyor belt, particularly preferably a conveyor belt in the mining industry.

Hereinafter, the present invention further illustrated by examples which are not intended to affect the scope of the application in any way.

### EXAMPLES

### Description of the Test Methods

The gelling time was determined using a test specimen of 100 g of components A+B by placing the mixture in a thermally insulated container (made of styrofoam) and stirring thoroughly every 30 seconds manually with a spatula. This was repeated for a total of 5 minutes, if possible. The gelling time is the time after which it is no longer possible to readily move the spatula.

The Shore A hardness after 60 minutes and 24 hours was determined by ASTM D 2240 (standard test for rubber properties, durometer hardness) or DIN 53505 for soft materials at three points in the material.

The viscosity after 1 and 7 days, respectively, was determined using a Brookfield viscometer (200 ml sample), spindle 3, at 20° C. and 20 rpm. The values are stated in MPa s⁻¹.

The elongation at break after one day was determined using ASTM D 412. A piece of the product was cut to a shape according to ASTM D 412 and clamped in a QZtech BST-2000-testing machine. The elongation was increased with a constant force until the product broke, which was automatically registered by the device.

The sturdiness or adhesive strength to natural rubber, synthetic rubber and fibers was determined by a method similar to ASTM 1876-01. All preparations/measurements were carried out at 20° C. and 35 to 50% relative humidity. The test specimens were prepared at 20° C. and 40% relative humidity and measured at 20° C. The measurement is described in more detail below:

Preparation of the T Peel Test Specimen:

Two surfaces of 305×152 mm were bonded using the composition, the thickness of the composition being about 0.8 mm, and an upper zone of 76 mm was left without any composition. The surfaces come from conveyor belts of the EP 200 series and contain a rubber thickness of 5.5 mm and a nylon covering of 6 mm. The products have been checked for both rubber-rubber and a cover-cover bonding.

Application:

The adhesion promoter (trichlorocyanuric acid) was applied to the surface. After a short flash-off, the product was applied on the surface within 10 minutes at a thickness of 5 to 6 mm. This product was cured for at least 1 to 4 hours at 20° C.

Preparation for Measurement:

After curing, the T peel test specimen was cut to a width of 25 mm (per test specimen) and further cured for 1,3 and 7 days, respectively.

Measurement:

The test specimen described above was clamped in the QZtech BTS-2000 testing machine and subjected to a constant pulling force, wherein the force for pulling apart over a length of 127 mm was determined (in kg/mm). The values are stated in kg force or kiloponds.

In the following examples, the individual constituents of the polyurethane prepolymer component are referred to as component A, while the curing agent is referred to as the component B. For the preparation of component A, the polyurethane prepolymer, the solvent, the plasticizer, and optionally pigments, fillers, defoamers, and modifiers and desiccants were mixed. Then, component A containing the polyurethane prepolymer was mixed with the curing agent component B.

### Comparative Examples 1 to 10

An overview of the compositions of comparative examples 1 to 10 can be found in Table 1 below.

Comparative Examples 1 to 5, in which on the one hand polyols and on the other hand isocyanates have been used instead of a prepolymer, show a relatively low Shore A hardness after 60 minutes and also only a small elongation at break of up to 280. While in comparative example 6 the elongation at break could be increased to 400, even this composition has a low Shore A hardness. In addition, the gelling time increases significantly in comparative example 6, indicating slow curing. Therefore, the corresponding materials are relatively unsuitable for repairing conveyor belts.

Comparative examples 7 to 9 do not contain any solvent and show overall higher Shore A hardness after 60 minutes compared to comparative examples 1 to 6. However, the elongation at break values at up to 320 are still very low. The addition of the solvent in comparative example 10 has further improved both elongation at break and the Shore A hardness. This comparative example does not contain any plasticizer in contrast to the compositions according to the invention.

TABLE 1

| Part of | | | | | | | | | | | | |
|---|---|---|---|---|---|---|---|---|---|---|---|---|
| component | Function | Starting material | V1 | V2 | V3 | V4 | V5 | V6 | V7 | V8 | V9 | V10 |
| B | Catalyst | Dabco ¹⁾ | 0.1% | 0.1% | 0.1% | 0.1% | 0.1% | | | | | |
| B | Catalyst | MXDA ²⁾ | 0.6% | 0.5% | 0.6% | 0.5% | 0.6% | | | | | |
| B | Catalyst | TETA ³⁾ | 0.2% | | | | | | | | | |
| A | Defoamer | BYK A 501 | | | | | | | 0.9% | 0.9% | 0.9% | 0.9% |
| A | Filler | Calcium carbonate | | | | | | | 49.9% | 50.2% | 22.4% | 19.6% |
| A | Filler | Kaolin | 29.5% | 24.0% | 28.2% | 26.1% | 27.2% | | | | | |
| B | Curing agent | DETDA ⁴⁾ | | | | | | | | 3.9% | 6.5% | 6.9% |
| B | Curing agent | DMTDA ⁵⁾ | | | | | | | 4.6% | | | |
| A | Pigment | Black iron oxide | 0.5% | 0.4% | 0.5% | 0.5% | 0.5% | | | | | |
| A | Pigment | Carbon black | | | | | | | 1.7% | 1.7% | 4.7% | 3.7% |
| A | Plasticizer | Benzyl alcohol | 4.1% | | | | | | | | | |
| A | Plasticizer | DBP ⁶⁾ | 0.1% | 0.1% | 0.1% | 0.1% | 0.1% | | | | | |
| A | Plasticizer | Hirenol PL 50 | | 28.8% | 17.5% | 12.9% | 4.2% | | | | | |
| A | Polyol | 1,4-Butanediol | 2.4% | 2.0% | 2.3% | 2.1% | 2.2% | | | | | |
| A | Polyol | Castor oil base ⁷⁾ | | | | 8.6% | 12.6% | 60.0% | | | | |
| A | Polyol | Polyether polyol ⁸⁾ | 36.5% | 29.7% | 34.9% | 32.3% | 33.6% | | | | | |
| A | Prepolymer | Polyether-TDI ⁹⁾ | | | | | | | | | | 31.7% |
| A | Prepolymer | Polyether-TDI ¹⁰⁾ | | | | | | | 43.0% | 43.3% | 65.4% | 31.7% |
| A | Rheology modifier | Fumed silica ¹¹⁾ | | | | | | | | | | |
| A | Rheology modifier | Fumed silica ¹²⁾ | 1.1% | 0.9% | 1.0% | 1.0% | 1.0% | | | | | |
| A | Solvent | MIBK ¹³⁾ | | | | | | | | | | 5.6% |
| A | Solvent | Xylol | 8.1% | | | | | | | | | |
| A | Water absorbent | Additive TI | | | | | | | | | | |
| A | Water absorbent | Baylith L powder | 2.2% | 1.8% | 2.1% | 1.9% | 2.0% | | | | | |
| | | MDI | 14.6% | 11.7% | 12.6% | 13.8% | 15.8% | 40.0% | | | | |

| | |
|---|---|
| TOTAL | 100.0% |

¹⁾ Diazabicyclo[2.2.2]octane,
²⁾ meta-xylidenediamine,
³⁾ triethylenetetramine,
⁴⁾ diethyltoluylenediamine,
⁵⁾ dimethylthiotoluylenediamine,
⁶⁾ dibutyl phthalate,
⁷⁾ branched castor oil-based polyol,
⁸⁾ linear polypropylene oxide/polyethylene oxide polyol, ethylene oxide terminated, with a theoretical OH functionality of 2 and an average molecular weight of about 4000,
⁹⁾ based on a polytetramethylene glycoldiol, NCO content of 6.25%,
¹⁰⁾ NCO content of 4.4%,
¹¹⁾ specific surface area of 200 m²/g,
¹²⁾ specific surface area of 110 m²/g,
¹³⁾ methyl isobutyl ketone.

The results of the determination of the gelling time, the Shore A hardness and elongation at break are shown in Table 2 below.

TABLE 2

| | Experiment no. | | | | | | | | | |
|---|---|---|---|---|---|---|---|---|---|---|
| TESTS | V1 | V2 | V3 | V4 | V5 | V6 | V7 | V8 | V9 | V10 |
| Gelling time | 15 | 5 | 4 | 4 | 3 | 25 | 10 | 2 | 2 | 1.5 |
| Shore A hardness | 50 | 50 | 65 | 55 | 60 | 40 | 50 | 60 | 70 | 75 |
| 60 minutes | | | | | | | | | | |
| Shore A hardness | 50 | 60 | 70 | 65 | 70 | 50 | 55 | 70 | 75 | 80 |
| 24 hours | | | | | | | | | | |
| Elongation at | 180 | 220 | 250 | 250 | 220 | 400 | 300 | 300 | 320 | 350 |
| break [%] 1 day | | | | | | | | | | |

### Examples 1 to 7 and Comparative Example 11

The compositions of these examples are shown in the following Table 3

TABLE 3

| Part of | | | | | | | | | | |
|---|---|---|---|---|---|---|---|---|---|---|
| component | Function | Starting material | 1 | 2 | 3 | 4 | 5 | 6 | 7 | V11 |
| A | Defoamer | BYK 300 | | | | | 1.4% | | | |
| A | Defoamer | BYK 540 | | | 0.6% | 0.9% | | 0.5% | | |
| A | Defoamer | BYK A 501 | 0.6% | 0.6% | | | | | | |
| A | Defoamer | Mitell S | | | | | | | 0.4% | 0.4% |
| A | Defoamer | Schewo foam | | | | | 1.4% | | | |
| | | 6351 | | | | | | | | |
| A | Filler | Calcium | 24.4% | | | | | | | |
| | | carbonate | | | | | | | | |
| B | Curing agent | DETDA ¹⁾ | 6.0% | 6.4% | 6.4% | 7.1% | 7.1% | 7.4% | 7.4% | |
| B | Curing agent | Methylene | | | | | | | | 7.4% |
| | | dianiline (MDA) | | | | | | | | |
| A | Pigment | Black iron oxide | | | | | | 0.6% | 1.1% | 1.1% |
| A | Pigment | Carbon black | 5.1% | 1.3% | 1.9% | 1.9% | 1.9% | 1.6% | 1.5% | 1.5% |
| A | Plasticizer | DBP ²⁾ | 9.4% | 5.6% | 5.6% | 5.6% | | 4.5% | 5.9% | 5.9% |
| A | Plasticizer | POLURENE LP | | | 10.7% | 10.2% | 10.2% | 8.2% | | |
| | | 100 LV ³⁾ | | | | | | | | |
| A | Plasticizer | Polurene LP100 ³⁾ | | 15.0% | | | | | | |
| A | Prepolymer | Polyether-TDI ⁴⁾ | 47.0% | | 33.7% | 44.6% | 44.6% | 47.1% | 46.1% | 46.1% |
| A | Prepolymer | Polyester-TDI ⁵⁾ | | 33.7% | 33.7% | 22.3% | 22.3% | 23.1% | 22.6% | 22.6% |
| A | Solvent | Ethyl acetate | | 3.7% | 7.5% | 7.4% | 11.2% | 6.4% | 6.8% | 6.8% |
| A | Solvent | MIBK ⁶⁾ | 7.5% | 33.7% | | | | | | |
| A | Solvent | Xylene | | | | | | | 8.3% | 8.3% |
| A | Water absorbent | Additive TI | | | | | | 0.6% | | |

¹⁾ Diethyltoluylenediamine,
²⁾ dibutyl phthalate,
³⁾ PU prepolymer with blocked NCO,
⁴⁾ based on a polytetramethylene glycol diol, NCO content 6.25%,
⁵⁾ NCO content 2.9%,
⁶⁾ methyl isobutyl ketone.

The properties of the compositions were determined as described above and are reported in the following Table 4:

TABLE 4

| | Experiment no. | | | | | | | |
|---|---|---|---|---|---|---|---|---|
| TESTS | 1 | 2 | 3 | 4 | 5 | 6 | 7 | V11 |
| Gelling time | 1 | 3 | 4 | 3 | 3 | 3 | 3 | 1 |
| Shore A hardness | 75 | 60 | 50 | 70 | 70 | 70 | 70 | 55 |
| 60 minutes | | | | | | | | |
| Shore A hardness | 90 | 70 | 65 | 80 | 80 | 80 | 85 | 70 |
| 24 hours | | | | | | | | |
| Elongation at break | 350 | 450 | 450 | 400 | 450 | 400 | 600 | 670 |
| [%] 1 day | | | | | | | | |
| Viscosity (3/25/25) | | | 4000 | 3500 | 3200 | 3500 | 2600 | |
| 1 day | | | | | | | | |
| Viscosity (3/25/25) | | | 8500 | 7500 | 9000 | 7000 | 6000 | |
| 7 days | | | | | | | | |

In contrast to example 1, the composition of example 2 does not contain any filler. The comparison of the examples shows that a substantially improved elongation at break value can be obtained by leaving out the filler. Also, example 1 has a gel time of only 1 minute and therefore a very short processing time, which is unfavorable. The improved elongation at break value is confirmed in the following examples 3-7, which also do not contain any filler. In addition, example 7 shows an excellent elongation at break value of 600% and also very good properties in terms of Shore hardness after 60 minutes of 70. Comparative example 11, which is similar to the composition of example 7 and differs from it only in terms of the curing agent (MDA in the same molar ratio of amino groups to isocyanate groups was used instead of DETDA), shows slightly improved elongation at break when compared to example 7. A major drawback of this comparative example is the very short gelling time of 1 minute. In addition, after a similar cure time (60 min and 24 hours) this example shows a Shore A hardness that is about 20% lower than example 7.

### Examples 8 to 12

In examples 8-12, the effect of solvent additions on the properties of the compositions according to the invention was investigated. The compositions are given in Table 5 below:

TABLE 5

| Part of | | | | | | | |
|---|---|---|---|---|---|---|---|
| component | Function | Starting material | 8 | 9 | 10 | 11 | 12 |
| A | Defoamer | Mitell S | 0.3% | 0.3% | 0.3% | 0.3% | 0.3% |
| B | Curing agent | DETDA ¹⁾ | 7.4% | 7.4% | .4% | 7.4% | 7.4% |
| A | Pigment | Black iron oxide | 0.9% | 0.9% | 0.9% | 0.9% | 0.9% |
| A | Pigment | Carbon black | 1.8% | 1.8% | 1.8% | 1.8% | 1.8% |
| A | Plasticizer | DBP ²⁾ | 5.6% | 5.6% | 5.6% | 5.6% | 5.6% |
| A | Prepolymer | Polyether-TDI ³⁾ | 47.1% | 47.1% | 47.1% | 47.1% | 47.1% |
| A | Prepolymer | Polyester-TDI ⁴⁾ | 23.1% | 23.1% | 23.1% | 23.1% | 23.1% |
| A | Solvent | Ethyl acetate | 5.6% | 5.6% | 5.6% | 5.6% | 5.6% |
| A | Solvent | Heptane | | | 2.8% | 1.4% | |
| A | Solvent | Hexane | | 2.8% | | 1.4% | |
| A | Solvent | Toluene | | | | | 2.8% |
| A | Solvent | Trichloroethylene | 2.8% | | | | |
| A | Solvent | Xylene | 5.6% | 5.6% | 5.6% | 5.6% | 5.6% |
| A | Water | Additive TI | | | | | |
| | absorbent | | | | | | |

¹⁾ Diethyltoluylenediamine,
²⁾ dibutyl phthalate,
³⁾ based on a polytetramethylene glycol diol, NCO content: 6.25%,
⁴⁾ NCO content: 2.9%.

The properties of these compositions are shown in Table 6 below:

TABLE 6
TESTS

| | Experiment no. | | | | |
|---|---|---|---|---|---|
| Gelling time | 8 | 9 | 10 | 11 | 12 |
| Shore A hardness 60 minutes | 70 | 70 | 70 | 70 | 70 |
| Shore A hardness 24 hours | 85 | 85 | 85 | 85 | 85 |
| Elongation at break [%] 1 day | 600 | 600 | 600 | 600 | 650 |
| Viscosity (3/25/25) 1 day | 2700 | 2800 | 2700 | 2600 | 2400 |
| Viscosity (3/25/25) 7 days | 5800 | 6000 | 6000 | 6000 | 5500 |
| Adhesive force to natural rubber | 10 | 6 | 8 | 7 | 13 |
| 1 day (Kgf) | | | | | |
| Adhesive force to synthetic | 7 | 3.5 | 4 | 3.5 | 3 |
| rubber 1 day (Kgf) | | | | | |
| Adhesive force to fibers 1 day | 8 | 4 | 6 | 5 | 3 |
| (Kgf) | | | | | |

It has been shown that, while almost uniform Shore A hardness and elongation at break can be achieved, significant differences in the adhesive behavior towards different substrates could be observed. In particular, differences in adhesion are obtained depending on the solvent mixture used. If the solvent mixture contains trichloroethylene, overall the best adhesive bonds to natural rubber, synthetic rubber and fiber materials are obtained. Because of its toxicity this solvent has drawbacks in practice.

1. A polyurethane-based composition having at least two components, comprising:
a) a polyurethane prepolymer as a constituent of a first component;
b) a curing agent as a constituent of a second component that is physically separate from the first component;
c) a solvent; and
d) a plasticizer,
wherein the curing agent contains a mononuclear aromatic polyamine, wherein amine functions are substituents of a same aromatic ring, and the curing agent is present in an amount such that a molar ratio of all amine functions in the polyamine to all isocyanate functions in the composition is at least 0.7 to 1.

2. The polyurethane-based composition according to claim 1, wherein the polyurethane prepolymer comprises:
a reaction product of at least one polyisocyanate and at least one polyether polyol.

3. The polyurethane-based composition according to claim 1, wherein the polyurethane prepolymer constitutes 40 to 94% by weight of the composition.

4. The polyurethane-based composition according to claim 1, wherein the curing agent is present in the form of a diamine.

5. The polyurethane-based composition according to claim 1, wherein the curing agent is present in an amount of 4 to 12% by weight based on the total weight of the composition.

6. The polyurethane-based composition according to claim 1, wherein the solvent comprises an aromatic solvent.

7. The polyurethane-based composition according to claim 1, wherein the solvent is present in an amount of 1 to 60% by weight based on the total weight of the composition.

8. The polyurethane-based composition according to claim 1, wherein the plasticizer is present in an amount of 1 to 20% by weight based on the total weight of the adhesive.

9. The polyurethane-based composition according to claim 1, wherein the adhesive has, after curing for 1 hour, a Shore A hardness of at least 60 and an elongation at break after one day of at least 300%.

10. The polyurethane-based composition according to claim 1, wherein the adhesive additionally contains one or more additives selected from the group consisting of defoamers, fillers, pigments, and rheology modifiers and water-absorbing agents.

11. A method for repairing defects in elastic substrates, comprising:
a) mixing a composition having at least two components, comprising:
a) a polyurethane prepolymer as a constituent of a first component;
b) a curing agent as a constituent of a second component that is physically separate from the first component;
c) a solvent; and
d) a plasticizer,
wherein the curing agent contains a mononuclear aromatic polyamine, wherein amine functions are substituents of a same aromatic ring, and the curing agent is present in an amount such that a molar ratio of all amine functions in the polyamine to all isocyanate functions in the composition is at least 0.7 to 1;
b) introducing the composition into the defects; and
c) curing the composition.

12. A method for bonding elastic substrates, comprising:
a) mixing a composition having at least two components, comprising:
a) a polyurethane prepolymer as a constituent of a first component;
b) a curing agent as a constituent of a second component that is physically separate from the first component;
c) a solvent; and
d) a plasticizer,
wherein the curing agent contains a mononuclear aromatic polyamine, wherein amine functions are substituents of a same aromatic ring, and the curing agent is present in an amount such that a molar ratio of all amine functions in the polyamine to all isocyanate functions in the composition is at least 0.7 to 1;
b) coating a substrate S1 and optionally a substrate S2 with the composition;
c) contacting a portion of the substrate S1 coated with the composition with a substrate S2, such that the composition is disposed between the two substrates; and
d) curing the composition.

13. The method according to claim 11, comprising:
prior to applying the composition, treating the optionally cleaned substrate with a adhesion promoter.

14. (canceled)

15. (canceled)

16. The polyurethane-based composition according to claim 2, wherein that at least one of the polyether polyol is a polytetramethylene glycol polyol.

17. The polyurethane-based composition according to claim 1, wherein the polyurethane prepolymer constitutes 50 to 85% by weight of the composition.

18. The polyurethane-based composition according to claim 2, wherein the polyurethane prepolymer constitutes 60 to 80% by weight of the composition.

19. The polyurethane-based composition according to claim 1, wherein the curing agent is present in an amount of 5 to 9% by weight based on the total weight of the composition.

20. The polyurethane-based composition according to claim 18, wherein the curing agent is present in an amount of 6 to 8.5% by weight based on the total weight of the composition.

21. The polyurethane-based composition according to claim 1, wherein the solvent is present in an amount of 5 to 30% by weight based on the total weight of the composition.

22. The polyurethane-based composition according to claim 20, wherein the solvent is present in an amount of 10 to 20% by weight based on the total weight of the composition.

23. The polyurethane-based composition according to claim 1, wherein the plasticizer is present in an amount of 2 to 15% by weight based on the total weight of the adhesive.

24. The polyurethane-based composition according to claim 22, wherein the plasticizer is present in an amount of 3 to 7% by weight based on the total weight of the adhesive.

25. The polyurethane-based composition according to claim 1, wherein the adhesive has, after curing for 1 hour, a Shore A hardness of at least 70 and an elongation at break after one day of at least 350%.

26. The method according to claim 11, comprising:
prior to applying the composition, treating the optionally cleaned substrate with a chlorine-containing adhesion promoter.

27. The method according to claim 11, comprising:
prior to applying the composition, treating the optionally cleaned substrate with a trichloroisocyanuric acid.
